(19) United States
(12) Patent Application Publication
(10) Pub. No.: US 2026/0133430 A1
(43) Pub. Date: May 14, 2026

(54) THREE-DIMENSIONAL DISPLAY DEVICE INCLUDING RETROREFLECTOR

(71) Applicant: Samsung Electronics Co., Ltd., Suwon-si (KR)

(72) Inventors: Jaeseung CHUNG, Suwon-si (KR); Yongkyu Kim, Suwon-si (KR); Hongsuk Kim, Suwon-si (KR); Changkun Lee, Suwon-si (KR); Chilsung Choi, Suwon-si (KR)

(73) Assignee: Samsung Electronics Co., Ltd., Suwon-si (KR)

(21) Appl. No.: 19/183,469

(22) Filed: Apr. 18, 2025

Related U.S. Application Data
(63) Continuation of application No. PCT/KR2025/003877, filed on Mar. 26, 2025.

(30) Foreign Application Priority Data
Nov. 11, 2024 (KR) 10-2024-0159360

(51) Int. Cl. G02B 27/14; G02B 30/27

(52) U.S. Cl. CPC G02B 27/14; G02B 30/27

(57) ABSTRACT

A display device includes a beam splitter configured to reflect a part of incident light and transmit another part of the incident light, a retroreflector configured to reflect the incident light back in a direction opposite to a direction in which the incident light is incident, and an image projector on a side of the beam splitter, the image projector being configured to emit a light providing an image, wherein the image providing device, the beam splitter, and the retroreflector are arranged such that the light emitted from the image providing device is incident on the beam splitter, the light reflected from the beam splitter is incident on the retroreflector, and the light reflected by the retroreflector is incident on the beam splitter.

### CROSS-REFERENCE TO RELATED APPLICATIONS

This application is a by-pass continuation of International Application No. PCT/KR2025/003877, filed on Mar. 26, 2025, which is based on and claims priority to Korean Patent Application No. 10-2024-0159360, filed in the Korean Intellectual Property Office on Nov. 11, 2024, the disclosures of which are incorporated by reference herein in their entireties.

### 1. FIELD

The disclosure relates to a three-dimensional display device that includes a retroreflector that may be manufactured to have a low thickness.

### 2. DESCRIPTION OF RELATED ART

In general, three-dimensional images are achieved by the principle of stereo vision through a user's eyes, and binocular parallax, which occurs because both eyes are spaced about 65 mm apart from each other, is the most important factor in creating a sense of depth.

However, projection displays that implement a large screen by using an ultra-small display panel and a magnifying optical system have limitations in implementing three-dimensional images. When implementing a three-dimensional image on a projection display, user's face the inconvenience of needing to wear special glasses. Recently, projection display structures capable of implementing three-dimensional images without glasses have been proposed, but have limitations in that they have a large brightness loss and are difficult to miniaturize.

### SUMMARY

Provided is a three-dimensional display device that includes a retroreflector that may be manufactured to have a low thickness.

In addition, provided is a three-dimensional display device capable of implementing a three-dimensional image without glasses.

According to an aspect of the disclosure, a display device includes: a beam splitter including a first surface and a second surface opposite to the first surface, the beam splitter being configured to reflect a first part of incident light and transmit a second part of the incident light; a retroreflector facing the second surface of the beam splitter, the retroreflector being configured to reflect the incident light back in a direction opposite to a direction in which the incident light is incident upon the retroreflector; and an image projector on a side of the second surface of the beam splitter, the image projector being configured to emit a light providing an image, wherein the image projector, the beam splitter, and the retroreflector are arranged such that the light emitted from the image projector is incident on the second surface of the beam splitter while diverging obliquely, the incident light reflected from the beam splitter is incident on the retroreflector while diverging obliquely, and the incident light reflected by the retroreflector is incident on the second surface of the beam splitter while converging obliquely.

The image projector may include at least two image providing elements configured to respectively provide images with different viewpoints.

The beam splitter may be parallel to a plane defined by a first axis direction and a second axis direction perpendicular to the first axis direction, the light emitted from the image projector may travel in the first axis direction, and the at least two image providing elements may be arranged in the second axis direction.

The retroreflector may be parallel to the beam splitter or may be tilted at less than 45 degrees with respect to the beam splitter.

The display device may further include a mirror that faces the second surface of the beam splitter, and the mirror is configured to reflect, toward the beam splitter, the light emitted from the image projector.

The beam splitter may be parallel to a plane defined by a first axis direction and a second axis direction perpendicular to the first axis direction, and the mirror and the retroreflector may be adjacent to each other in the first axis direction.

The mirror and the retroreflector may be tilted in opposite directions such that a reflective surface of the mirror and a reflective surface of the retroreflector face each other.

The mirror may be tilted at a first angle with respect to the first axis direction, the retroreflector may be tilted at a second angle with respect to the first axis direction, and the first angle and the second angle are greater than or equal to 0 degrees and less than 45 degrees.

A reflective surface of the mirror and a reflective surface of the retroreflector may be parallel to and face the beam splitter.

The image projector may be arranged between the mirror and the beam splitter in a third axis direction that is perpendicular to the first axis direction and the second axis direction.

The image projector may be between the mirror and the retroreflector in the first axis direction, and the mirror may be tilted at an angle of less than 45 degrees with respect to a third axis direction, the third axis direction being perpendicular to the first axis direction and the second axis direction.

The retroreflector may be between the beam splitter and the image projector in the third axis direction.

A reflective surface of the mirror and a reflective surface of the retroreflector may be perpendicular to each other.

The incident light reflected by the retroreflector and transmitted through the beam splitter may converge into a viewing area adjacent to an edge of the beam splitter in the first axis direction.

The mirror may include a convex reflective surface.

The display device may further include a diffuser sheet on an optical path between the beam splitter and the retroreflector, the diffuser sheet being configured to expand a viewing area by diffusing the light reflected from the retroreflector.

The display device may further include an anti-reflection layer on the first surface of the beam splitter, the anti-reflection layer being configured to reduce reflection of light incident on the first surface of the beam splitter.

The display device may further include an optical path changing sheet on the first surface of the beam splitter, the optical path changing sheet being configured to change a direction of travel of the incident light transmitted through the beam splitter from the retroreflector, toward a front of the beam splitter.

The image projector may include a first image projector configured to emit a first light providing a first image, and a second image projector configured to emit a second light providing a second image, the retroreflector may include a first retroreflector configured to reflect the first light reflected from the beam splitter, and a second retroreflector configured to reflect the second light reflected from the beam splitter, the first image projector and the second image projector may be respectively adjacent to each edge of the beam splitter, and the first retroreflector and the second retroreflector may be tilted in opposite directions such that a reflective surface of the first retroreflector and a reflective surface of the second retroreflector do not face each other.

The image projector may include a first image projector configured to emit a first light providing a first image, and a second image projector configured to emit a second light providing a second image, the beam splitter and the retroreflector are parallel to each other, and the retroreflector may be between the first image projector and the second image projector.

### BRIEF DESCRIPTION OF THE DRAWINGS

The above and other aspects and features of certain embodiments of the present disclosure will be more apparent from the following description taken in conjunction with the accompanying drawings, in which:

FIG. 1 schematically illustrates a configuration of a three-dimensional display device according to one or more embodiments of the disclosure;

FIG. 2 illustrates an arrangement of a plurality of image providing elements of an image projector of a three-dimensional display device;

FIG. 3 schematically illustrates an arrangement relationship between an image projector, a mirror, and a retroreflector;

FIG. 4A illustrates a position of a viewing area when a mirror is tilted at a first tilt angle;

FIG. 4B illustrates a position of a viewing area when a mirror is tilted at a second tilt angle different from the first tilt angle;

FIG. 4C illustrate a position of a viewing area when a mirror is tilted at a third tilt angle different from the first tilt angle and the second tilt angle;

FIG. 5 schematically illustrates a configuration of a three-dimensional display device according to one or more embodiments of the disclosure;

FIG. 6 schematically illustrates a configuration of a three-dimensional display device according to one or more embodiments of the disclosure;

FIG. 7 schematically illustrates a configuration of a three-dimensional display device according to one or more embodiments of the disclosure;

FIG. 8 schematically illustrates a configuration of a three-dimensional display device according to one or more embodiments of the disclosure;

FIG. 9 schematically illustrates a configuration of a three-dimensional display device according to one or more embodiments of the disclosure;

FIG. 10 schematically illustrates a configuration of a three-dimensional display device according to one or more embodiments of the disclosure;

FIG. 11 schematically illustrates a configuration of a three-dimensional display device according to one or more embodiments of the disclosure;

FIG. 12 schematically illustrates a configuration of a three-dimensional display device according to one or more embodiments of the disclosure;

FIG. 13 schematically illustrates a configuration of a three-dimensional display device according to one or more embodiments of the disclosure; and

FIG. 14 schematically illustrates a configuration of a three-dimensional display device according to one or more embodiments of the disclosure.

### DETAILED DESCRIPTION

Hereinafter, a three-dimensional display device including a retroreflector will be described in detail with reference to the accompanying drawings. In the drawings, like reference numerals refer to like elements, and sizes of elements in the drawings may be exaggerated for clarity and convenience of description. Embodiments described below are merely examples, and various modifications are possible from the embodiments.

As used herein, the expressions “at least one of a, b or c” and “at least one of a, b and c” indicate “only a,” “only b,” “only c,” “both a and b,” “both a and c,” “both b and c,” and “all of a, b, and c.”

In the following descriptions, when an element is referred to as being “on” or “above”, or “below” or “under” another element, the element may be on/under/left to/right to the other element in contact therewith, or may be on/under/left to/right to the other element without contact. The singular expression also includes the plural meaning as long as it does not inconsistent with the context. In addition, when an element is referred to as “including” a component, the element may additionally include other components rather than excluding other components as long as there is no particular opposing recitation.

The term “the” and other demonstratives similar thereto should be understood to include a singular form and plural forms. Operations of a method described herein may be performed in any suitable order unless otherwise indicated herein or otherwise clearly contradicted by context, and the disclosure is not limited to the described order of the operations.

In addition, as used herein, the terms such as “ . . . er (or)”, “ . . . unit”, “ . . . module”, etc., denote a unit that performs at least one function or operation, which may be implemented as hardware or software or a combination thereof.

Line connections or connection members between elements depicted in the drawings represent functional connections and/or physical or circuit connections by way of example, and in actual applications, they may be replaced or embodied with various suitable additional functional connections, physical connections, or circuit connections.

The use of any and all examples, or exemplary language provided herein, is intended merely to describe the technical spirit of the disclosure in more detail and does not pose a limitation on the scope of the disclosure unless otherwise claimed.

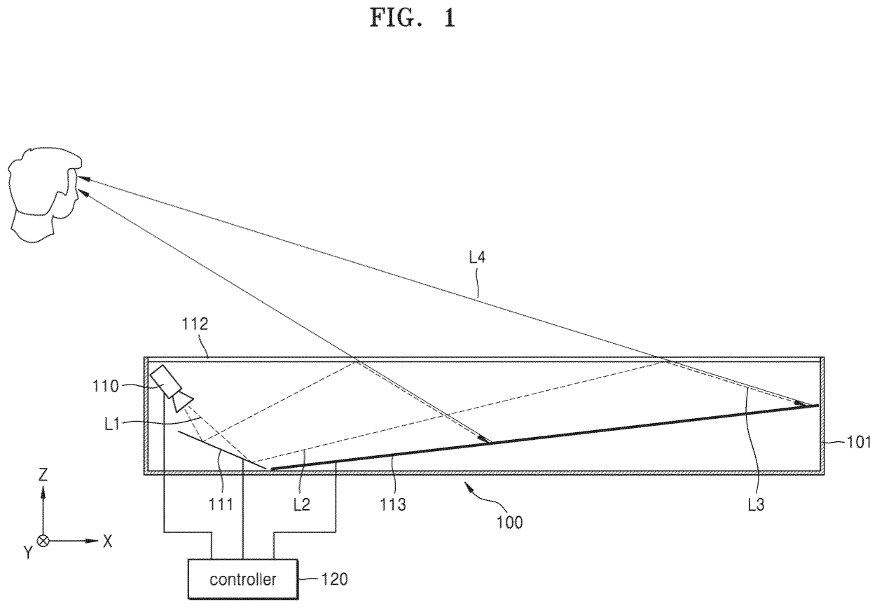

FIG. 1 schematically illustrates a configuration of a three-dimensional display device according to one or more embodiments of the disclosure. Referring to FIG. 1, a three-dimensional display device 100 may include an image projector 110, a mirror 111, a beam splitter 112, and a retroreflector 113.

The mirror 111 and the retroreflector 113 may be arranged to face the same surface of the beam splitter 112. For example, the mirror 111 and the retroreflector 113 may be arranged to face the lower surface of the beam splitter 112. To secure a wide viewing angle, the size of the retroreflector 113 may be larger than the size of the mirror 111. For example, the length of a reflective surface of the retroreflector 113 in a first axis direction (i.e., X-axis direction) may be at least about 2 times, at least about 3 times, or at least about 4 times the length of a reflective surface of the mirror 111 in the first axis direction (i.e., X-axis direction).

Assuming that the beam splitter 112 is arranged parallel to a horizontal plane formed by the first axis direction (i.e., X-axis direction) and a second axis direction (i.e., Y-axis direction) that is perpendicular to the first axis direction (i.e., X-axis direction), the mirror 111 and the retroreflector 113 may be arranged to be tilted with respect to the beam splitter 112. For example, each of the mirror 111 and the retroreflector 113 may include a reflective surface that faces the beam splitter 112 at an angle. The mirror 111 and the retroreflector 113 may be adjacent to each other in the first axis direction (i.e., X-axis direction), and may be tilted in opposite directions. For example, edges of the mirror 111 and the retroreflector 113 that are close to each other may be tilted relatively downward in a negative (−) third axis direction (i.e., −Z-axis direction) that is perpendicular to the first axis direction (i.e., X-axis direction) and the second axis direction (i.e., Y-axis direction), and edges that are far from each other may be tilted relatively upward in a positive (+) third axis direction (i.e., +Z-axis direction). Thus, the reflective surface of the mirror 111 and the reflective surface of the retroreflector 113 may at least partially face each other. In addition, the mirror 111 and the retroreflector 113 may be spaced apart from each other in the first axis direction (i.e., X-axis direction) so as not to overlap each other in the third axis direction (i.e., Z-axis direction).

The three-dimensional display device 100 may further include a housing 101. The beam splitter 112 may form the upper surface of the housing 101. Alternatively, the beam splitter 112 may be provided on the upper surface of the housing 101. FIG. 1 illustrates that the beam splitter 112 covers the entire upper portion of the housing 101, but the disclosure is not limited thereto. For example, the housing 101 may include a bezel extending along an upper rim portion thereof, and the beam splitter 112 may be supported by the bezel in an upper portion of the housing 101. The image projector 110, the mirror 111, the beam splitter 112, and the retroreflector 113 may be provided within a space formed between the beam splitter 112 and the housing 101.

The image projector 110 may be arranged to provide the mirror 111 with light containing an image to be viewed by a user, at an angle. For example, the image projector 110 may be arranged to face the reflective surface of the mirror 111 at an angle. The image projector 110, the mirror 111, and the retroreflector 113 may be provided on the same side of the beam splitter 112. For example, when the beam splitter 112 has a first surface on the outside of the three-dimensional display device 100 and a second surface opposite the first surface, the image projector 110, the mirror 111, and the retroreflector 113 may all face the second surface of the beam splitter 112. In the example illustrated in FIG. 1, the image projector 110 may be provided between the mirror 111 and the beam splitter 112 in the third axis direction (i.e., Z-axis direction).

The mirror 111 may be arranged to reflect, toward the beam splitter 112, light emitted from the image projector 110. Thus, light emitted from the image projector 110 and then reflected by the mirror 111 may be incident on the second surface of the beam splitter 112. The beam splitter 112 may be a semi-transparent mirror that reflects a part of incident light and transmits the remaining part. For example, the beam splitter 112 may reflect half of the incident light and transmit the other half. The light reflected by the beam splitter 112 may be incident on the retroreflector 113. The retroreflector 113 may be configured to reflect incident light back in the direction opposite to the direction of incidence. The light reflected by the retroreflector 113 may travel back in the direction opposite to the direction of incidence, to be incident on the second surface of the beam splitter 112. Thereafter, the light transmitted through the beam splitter 112 may travel toward a viewing area outside the three-dimensional display device 100. Accordingly, the user may view the image in the viewing area.

The light may travel from the image projector 110 to the viewing area along four different paths. For example, an optical path from the image projector 110 to the viewing area may include a first optical path L1 from the image projector 110 to the mirror 111, a second optical path L2 from the mirror 111 to the beam splitter 112, a third optical path L3 from the beam splitter 112 to the retroreflector 113, and a fourth optical path L4 from the retroreflector 113 to the viewing area.

The image projector 110 may emit divergent light having a beam diameter increasing in the direction of travel. Thus, in the first optical path L1, the light is divergent light. In the first optical path L1, the light may travel obliquely in the positive (+) first axis direction (i.e., +X-axis direction) and the negative (−) third axis direction (i.e., −Z-axis direction). In the second optical path L2, the light is divergent light and may travel obliquely in the positive (+) first axis direction (i.e., +X-axis direction) and the positive (+) third axis direction (i.e., +Z-axis direction). In the third optical path L3, the light is divergent light and may travel obliquely in the positive (+) first axis direction (i.e., +X-axis direction) and the negative (−) third axis direction (i.e., −Z-axis direction). Because the retroreflector 113 returns incident light in the direction opposite to the direction of incidence, the light in the fourth optical path L4 is convergent light. In addition, in the fourth optical path L4, the light may travel obliquely in the negative (−) first axis direction (i.e., −X-axis direction) and the positive (+) third axis direction (i.e., +Z-axis direction). Thus, from the first optical path L1 to the third optical path L3, the light may travel while diverging in the positive (+) first axis direction (i.e., +X-axis direction), and in the fourth optical path L4, the light may converge to the viewing area while traveling in the negative (−) first axis direction (i.e., −X-axis direction).

Because the viewing area is formed as the light transmits through the beam splitter 112 and then travels along the fourth optical path L4, the viewing area may be formed near the edge of the three-dimensional display device 100 or near an edge of (e.g., adjacent to) the beam splitter 112 in the first axis direction (i.e., X-axis direction). In particular, the viewing area may be formed near an edge of the three-dimensional display device 100 or near an edge of the beam splitter 112 in the negative (−) first axis direction (i.e., −X axis direction). For example, the viewing area may be formed outside an edge of the three-dimensional display device 100 or outside an edge of the beam splitter 112 in the negative (−) first axis direction (i.e., −X-axis direction).

The three-dimensional display device 100 according to one or more embodiments of the disclosure may be manufactured to have a small thickness through the above-described arrangement structure of the image projector 110, the mirror 111, the beam splitter 112, and the retroreflector 113. For example, the three-dimensional display device 100 according to one or more embodiments of the disclosure may be applied to a notebook personal computer (PC), a laptop PC, a tabletop PC, a tablet PC, etc. In addition, according to one or more embodiments of the disclosure, because the light travels toward the viewing area while converging, a relatively bright image may be provided to the viewing area.

The three-dimensional display device 100 may provide a single two-dimensional image, but may also implement a three-dimensional image by providing the viewing area with a plurality of images with different viewpoints. To this end, the image projector 110 of the three-dimensional display device 100 may include an array of at least two image providing elements configured to provide images with different viewpoints, respectively. When the image projector 110 includes an array of at least two image providing elements, the plurality of image providing elements may be arranged at intervals in the second axis direction (i.e., Y-axis direction). Accordingly, the three-dimensional display device 100 according to one or more embodiments of the disclosure may implement a three-dimensional image without separate glasses.

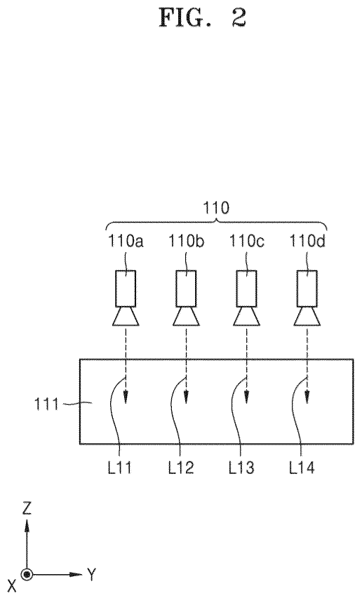

FIG. 2 illustrates an arrangement of a plurality of image providing elements of the image projector 110 of the three-dimensional display device 100. Referring to FIG. 2, the image projector 110 may include a first image providing element 110a, a second image providing element 110b, a third image providing element 110c, and a fourth image providing element 110d that are arranged at regular intervals in the second axis direction (i.e., Y-axis direction). The first image providing element 110a may provide a first light L11 containing a first image having a first viewpoint. The second image providing element 110b may provide a second light L12 containing a second image having a second viewpoint different from the first viewpoint. The third image providing element 110c may provide a third light L13 containing a third image having a third viewpoint different from the first and second viewpoints. The fourth image providing element 110d may provide a fourth light L14 containing a fourth image having a fourth viewpoint different from the first to third viewpoints.

The first to fourth lights L11, L12, L13, and L14 may be emitted toward one mirror 111. The first to fourth lights L11, L12, L13, and L14 may be incident on different areas on the mirror 111. For example, the first to fourth lights L11, L12, L13, and L14 may be incident on different areas on the mirror 111 that are arranged at regular intervals in the second axis direction (i.e., Y-axis direction). The first to fourth lights L11, L12, L13, and L14 reflected by the mirror 111 may travel sequentially along the second optical path L2, the third optical path L3, and the fourth optical path L4 described above, and may then be provided to the viewing area. In the viewing area, the first to fourth lights L11, L12, L13, and L14 may be spaced apart at regular intervals in the second axis direction (i.e., Y-axis direction).

FIG. 2 illustrates that the image projector 110 includes four image providing elements, but the number of image providing elements is not limited to four. For example, the image projector 110 may include only two image providing elements. For example, the image projector 110 may include only the first image providing element 110a and the second image providing element 110b. In this case, the first image providing element 110a may provide a right-eye image, and the second image providing element 110b may provide a left-eye image. The first image providing element 110a and the second image providing element 110b may be arranged apart from each other in the second axis direction (i.e., Y-axis direction) by a distance corresponding to the distance between the user's left and right eyes.

Alternatively, the image projector 110 may include three, four, five, or more image providing elements. In this case, the distance between two adjacent image providing elements may be less than the distance between the user's eyes. In addition, a viewpoint difference between two images provided by two immediately adjacent image providing elements may be less than a viewpoint difference between the user's left and right eyes. Accordingly, the user may view images with more subdivided various viewpoints in a relatively wide viewing area.

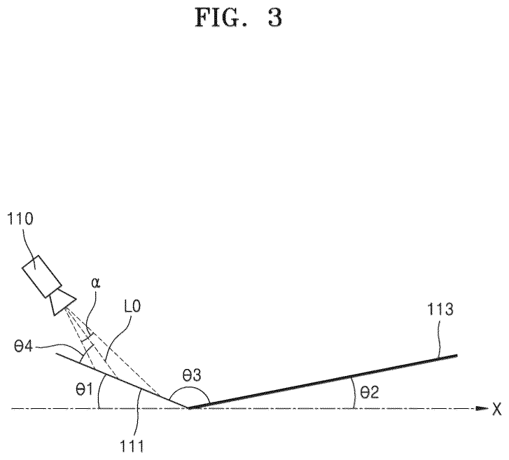

In addition, the position of the viewing area may be determined by an arrangement relationship between the image projector 110, the mirror 111, the beam splitter 112, and the retroreflector 113. FIG. 3 schematically illustrates an arrangement relationship between the image projector 110, the mirror 111, and the retroreflector 113. Referring to FIG. 3, assuming that the beam splitter 112 is arranged parallel to a horizontal plane formed by the first axis direction (i.e., X-axis direction) and the second axis direction (i.e., Y-axis direction), the mirror 111 may be arranged to be tilted at a first angle θ1 with respect to the first axis direction (i.e., X-axis direction). The retroreflector 113 may be arranged to be tilted at a second angle θ2 with respect to the first axis direction (i.e., X-axis direction). Here, the first angle θ1 and the second angle θ2 may be angles indicated as acute angles less than 90 degrees from the first axis direction (i.e., X-axis direction). In this case, the angle between the reflective surface of the mirror 111 and the reflective surface of the retroreflector 113 is a third angle θ3, and the third angle (θ3) may have a relationship of θ3=180−(θ1+θ2). The image projector 110 may be arranged to be tilted at a fourth angle θ4 with respect to the reflective surface of the mirror 111. For example, among lights emitted from the image projector 110, a central light L0 may be incident on the mirror 111 at the fourth angle θ4. The image projector 110 may emit light at a certain divergence angle α. Here, the divergence angle α may be defined as an angle between peripheral lights among lights emitted from the image projector 110.

According to one or more embodiments of the disclosure, the position of the viewing area and the size of an image may be determined based on various factors such as the first angle θ1 to the fourth angle θ4, the distance between the mirror 111 and the retroreflector 113 in the first axis direction (i.e., X-axis direction), the distance between the mirror 111 and the beam splitter 112 in the third axis direction (i.e., Z-axis direction), the distance between the retroreflector 113 and the beam splitter 112 in the third axis direction (i.e., Z-axis direction), or the divergence angle α of the image projector 110. In the design process of the three-dimensional display device 100, an optimal position of the viewing area may be determined, and design values for the first angle θ1 to the fourth angle θ4, the distance between the mirror 111 and the retroreflector 113 in the first axis direction (i.e., X-axis direction), the distance between the mirror 111 and the beam splitter 112 in the third axis direction (i.e., Z-axis direction), and the distance between the retroreflector 113 and the beam splitter 112 in the third axis direction (i.e., Z-axis direction) may be determined according to the determined position of the viewing area, and then the three-dimensional display device 100 may be manufactured according to the design values.

In an example, the three-dimensional display device 100 may have a fixed optimal position of the viewing area as predetermined during the design process. In another example, assuming that the positions of the image projector 110, the mirror 111, the beam splitter 112, and the retroreflector 113 are fixed within the housing 101, it is also possible for the user to adjust the position of the viewing area to suit the user by adjusting at least one of the first angle θ1 to the fourth angle θ4. For example, referring back to FIG. 1, the three-dimensional display device 100 may further include a controller 120 configured to adjust at least one of the first angle θ1 to the fourth angle θ4. FIG. 1 illustrates that the controller 120 is outside the housing 101 for convenience of description, but the controller 120 may be mounted inside the housing 101. The controller 120 may include an input panel for receiving a command from the user, such as a keypad or a touch pad. The controller 120 may be configured to adjust the tilt angle of at least one of the image projector 110, the mirror 111, or the retroreflector 113 according to a command of the user. For example, the controller 120 may include a motor or an actuator for adjusting the tilt of each of the image projector 110, the mirror 111, and the retroreflector 113, and may electrically control the operation of the motor or actuator to adjust the tilt angle of at least one of the image projector 110, the mirror 111, or the retroreflector 113.

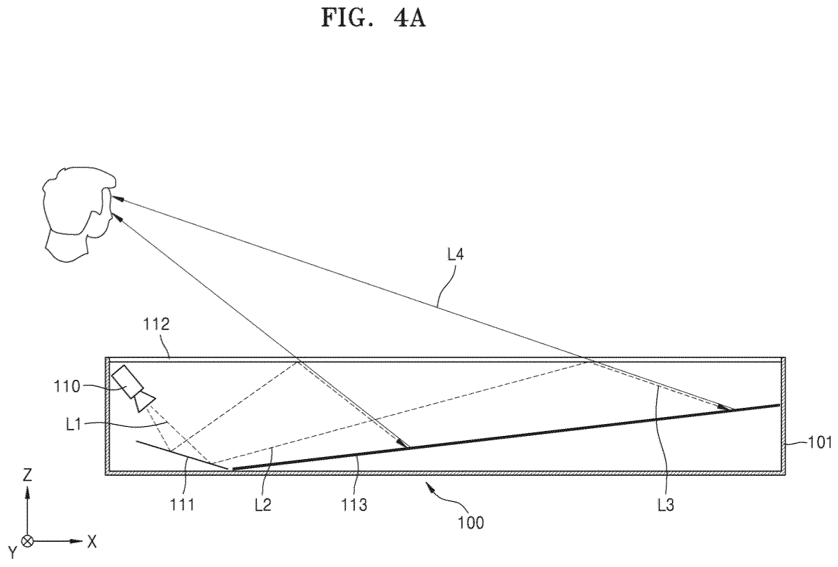

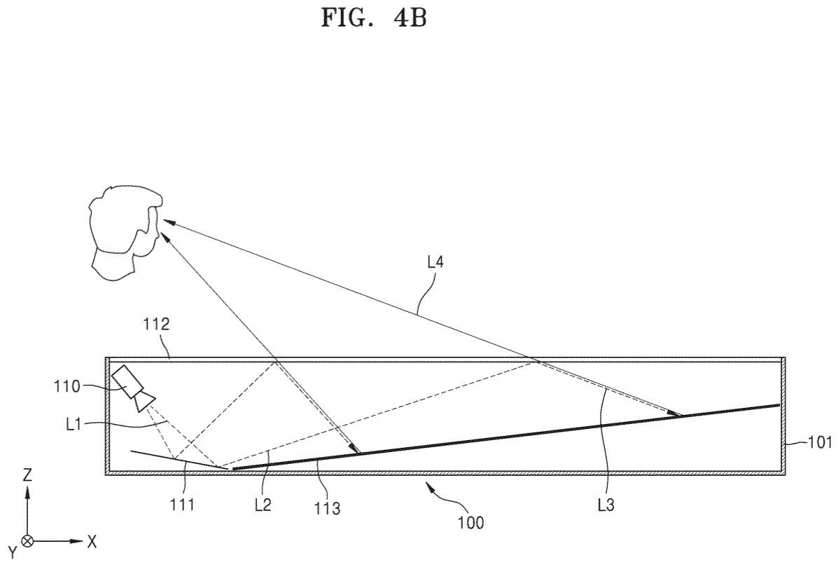

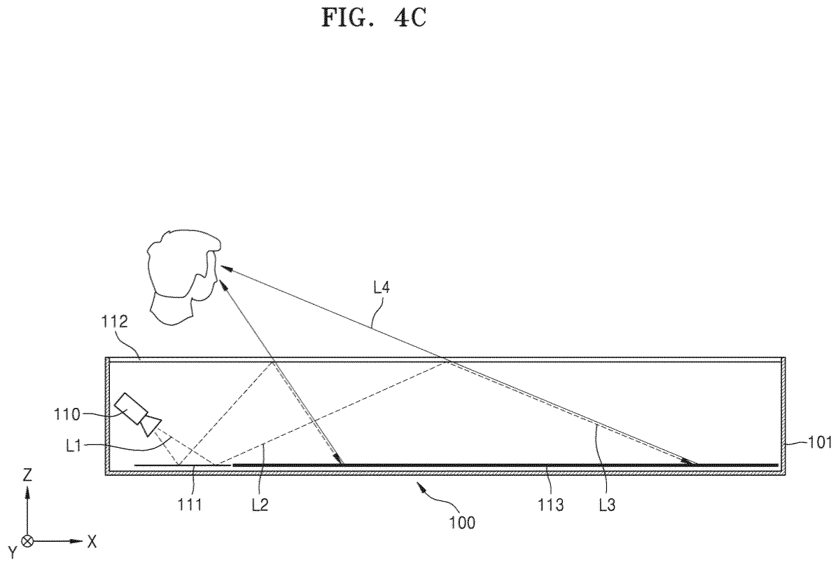

FIGS. 4A to 4C illustrate changes in the position of the viewing area according to a tilt angle of the mirror 111. Referring to FIGS. 4A to 4C, as the tilt angle of the mirror 111, i.e., the first angle θ1, decreases, the position of the viewing area may shift in the positive (+) first axis direction (i.e., X-axis direction). In other words, as the first angle θ1 of the mirror 111 decreases, the position of the viewing area may shift in the first axis direction (i.e., X-axis direction) from the edge of the three-dimensional display device 100 toward the center of the three-dimensional display device 100, or from the edge of the beam splitter 112 toward the center of the beam splitter 112, and as the first angle θ1 of the mirror 111 increases, the position of the viewing area may shift in the first axis direction (i.e., X-axis direction) from the center of the three-dimensional display device 100 toward the edge, or from the center of the beam splitter 112 toward the edge. As the fourth angle θ4 of the image projector 110 increases, the position of the viewing area may shift in the first axis direction (i.e., X-axis direction) from the edge of the three-dimensional display device 100 toward the center, and as the fourth angle θ4 of the image projector 110 decreases, the position of the viewing area may shift in the first axis direction (i.e., X-axis direction) from the center of the three-dimensional display device 100 toward the edge.

As illustrated in FIG. 4C, it is also possible for the mirror 111 and the retroreflector 113 to be adjacent to each other in parallel in the first axis direction (i.e., X-axis direction) on the same plane. In this case, the reflective surface of the mirror 111 and the reflective surface of the retroreflector 113 may be parallel to and face the beam splitter 112. In other words, the first angle θ1 of the mirror 111 and the second angle θ2 of the retroreflector 113 may be 0 degrees, and the third angle θ3 between the reflective surface of the mirror 111 and the reflective surface of the retroreflector 113 may be 180 degrees. As such, the first angle θ1 and the second angle θ2 may be 0 degrees or greater, and the third angle θ3 may be 180 degrees or less. In addition, when the first angle θ1 and the second angle θ2 are excessively large, the thickness of the three-dimensional display device 100 may increase. Considering the thickness of the three-dimensional display device 100 and an appropriate position of the viewing area, the first angle θ1, the second angle θ2, and the fourth angle θ4 may be, for example, less than 45 degrees, or 30 degrees or less, and the third angle θ3 may be, for example, 90 degrees or greater, or 120 degrees or greater. In particular, the second angle θ2 of the retroreflector 113 may be, for example, 0 degrees or greater but less than 45 degrees, 0 degrees to 30 degrees, or 0 degrees to 25 degrees. Thus, the retroreflector 113 may be parallel to the beam splitter 112, or may be tilted at less than 45 degrees, at 30 degrees or less, or at 25 degrees or less, with respect to the beam splitter 112.

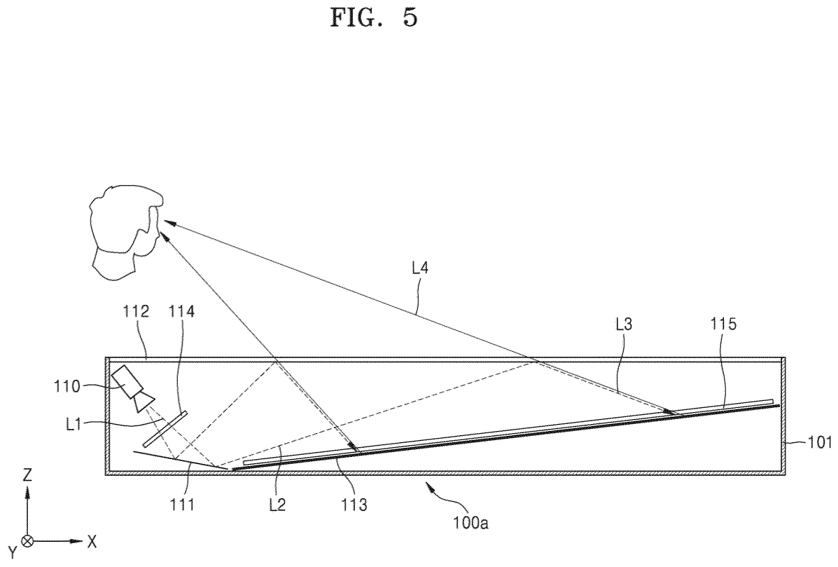

FIG. 5 schematically illustrates a configuration of a three-dimensional display device according to one or more embodiments of the disclosure. In the example illustrated in FIG. 1, the beam splitter 112 is described as a simple semi-transparent mirror, but the beam splitter 112 may also be a polarizing beam splitter that reflects light of a particular polarization component and transmits light of another polarization component. Referring to FIG. 5, a three-dimensional display device 100a may further include a polarizing plate 114 provided in an optical path between the image projector 110 and the mirror 111, and a quarter-wave plate 115 provided in an optical path between the beam splitter 112 and the retroreflector 113. The polarizing plate 114 may be, for example, an absorptive polarizing plate that transmits only light having a first linear polarization component and absorbs light having a second linear polarization component perpendicular to the first linear polarization component. The beam splitter 112 may be a polarizing beam splitter that reflects light having a first linear polarization component and transmits light having a second linear polarization component. The other configurations and components of the three-dimensional display device 100a illustrated in FIG. 5 may be identical to that of the three-dimensional display device 100 illustrated in FIG. 1.

In the above-described configuration, only a light having the first linear polarization component among lights emitted from the image projector 110 may transmit through the polarizing plate 114 and then be incident on the beam splitter 112. The light having the first linear polarization component is reflected by the beam splitter 112 and then transmits through the quarter-wave plate 115 to have a first circular polarization component. The light having the first circular polarization component is reflected by the retroreflector 113 and thus becomes light having a second circular polarization component having a direction opposite to that of the first circular polarization component. The light having the second circular polarization component may pass through the quarter-wave plate 115, thus becoming light having a second linear polarization component, and then transmit through the beam splitter 112.

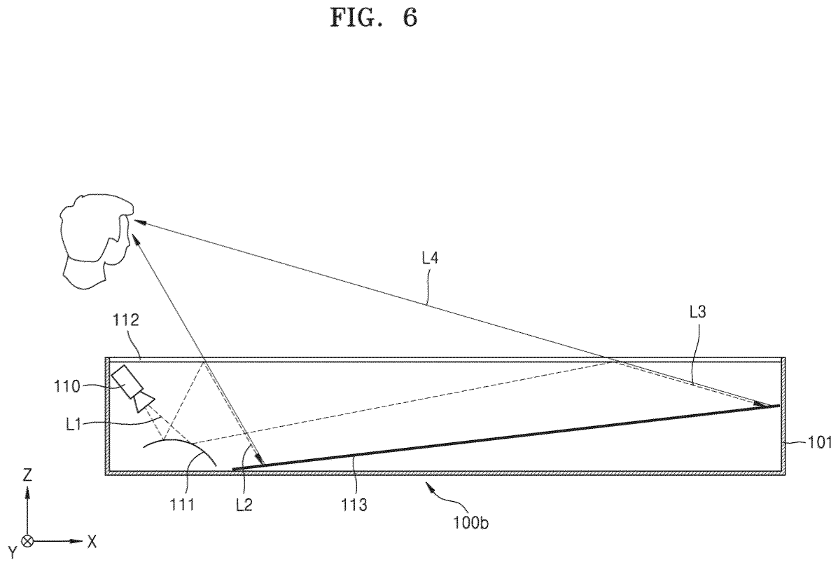

FIG. 6 schematically illustrates a configuration of a three-dimensional display device according to one or more embodiments of the disclosure. It has been described that the mirror 111 is a flat mirror, but the mirror 111 may be a curved mirror as needed. For example, referring to FIG. 6, the mirror 111 of a three-dimensional display device 100b may be a convex curved mirror having a convex reflective surface. When the mirror 111 is a convex curved mirror, the divergence angle of light in the second optical path L2 and the third optical path L3 and a convergence angle of light in the fourth optical path L4 may increase, such that an image is further enlarged. When the divergence angle α of the image projector 110 is relatively small or it is difficult to secure a sufficient length of the optical path within the housing 101, an image of a sufficient size may be implemented by enlarging the image by using a convex curved mirror.

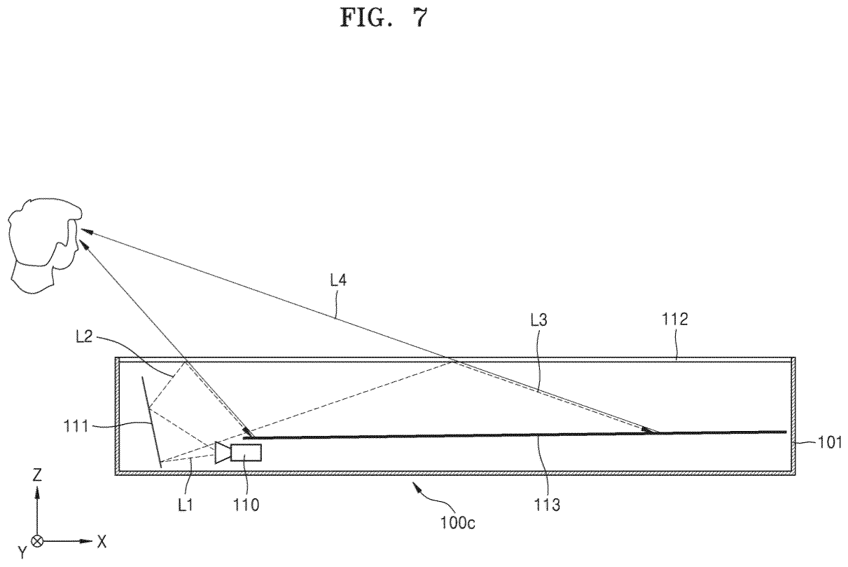

FIG. 7 schematically illustrates a configuration of a three-dimensional display device according to one or more embodiments of the disclosure. It has been described that the image projector 110 is arranged between the beam splitter 112 and the mirror 111 in the third axis direction (i.e., Z-axis direction), and that light in the first optical path L1 travels obliquely in the positive (+) first axis direction (i.e., +X-axis direction) and the negative (−) third axis direction (i.e., −Z-axis direction). However, it is also possible to configure the arrangement of the beam splitter 112 and the mirror 111 differently. Referring to FIG. 7, in a three-dimensional display device 100c, an image projector 110 may be provided between the mirror 111 and the retroreflector 113 in the first axis direction (i.e., X-axis direction). In addition, the image projector 110 may face a lower portion of the reflective surface of the mirror 111 in the third axis direction (i.e., Z-axis direction). For example, the image projector 110 may be provided lower than the retroreflector 113 in the third axis direction (i.e., Z-axis direction). In other words, the retroreflector 113 may be positioned between the beam splitter 112 and the image projector 110 in the third axis direction (i.e., Z-axis direction).

In this configuration, in the first optical path L1, light may travel obliquely in the negative (−) first axis direction (i.e., −X-axis direction) and the positive (+) third axis direction (i.e., +Z-axis direction). In addition, the first angle θ1, which is the tilt angle of the mirror 111, may be determined based on the third axis direction (i.e., Z-axis direction) rather than the first axis direction (i.e., X-axis direction). That is, the mirror 111 may be tilted at the first angle θ1 with respect to the third axis direction (i.e., Z-axis direction). For example, the first angle θ1 of the mirror 111 with respect to the third axis direction (i.e., Z-axis direction) may be less than 45 degrees, or 30 degrees or less.

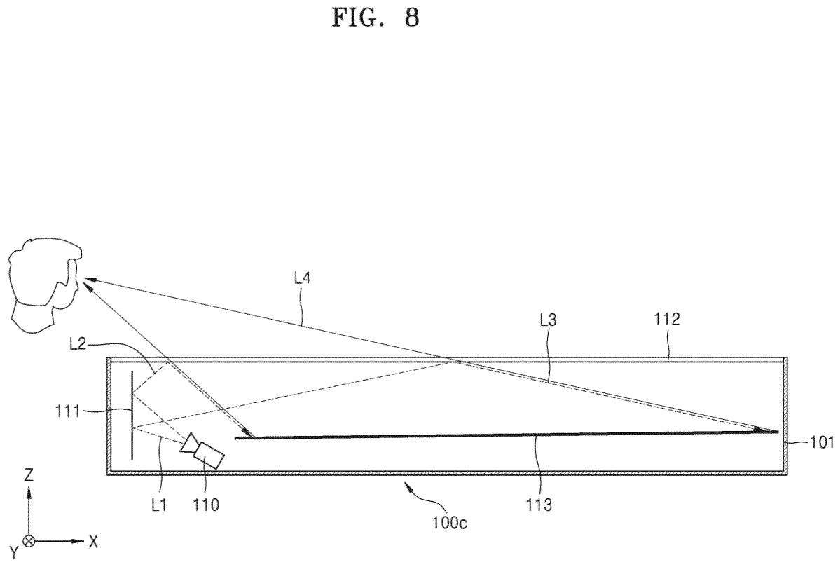

FIG. 8 schematically illustrates a configuration of a three-dimensional display device according to one or more embodiments of the disclosure. Referring to FIG. 8, the mirror 111 may be provided perpendicular to the first axis direction (i.e., X direction) and parallel to the third axis direction (i.e., Z-axis direction). In other words, the first angle θ1 of the mirror 111 with respect to the third axis direction (i.e., Z-axis direction) may be 0 degrees. The retroreflector 113 may be arranged parallel to the first axis direction (i.e., X direction). In other words, the second angle θ2 of the retroreflector 113 with respect to the first axis direction (i.e., X-axis direction) may be 0 degrees. In this case, the reflective surface of the mirror 111 and the reflective surface of the retroreflector 113 may be perpendicular to each other. However, the disclosure is not limited thereto, and as described above, the retroreflector 113 may be tilted at less than 45 degrees, at 30 degrees or less, or at 25 degrees or less, with respect to the first axis direction (i.e., X-axis direction). In this case, the third angle θ3 between the reflective surface of the mirror 111 and the reflective surface of the retroreflector 113 may be less than 90 degrees.

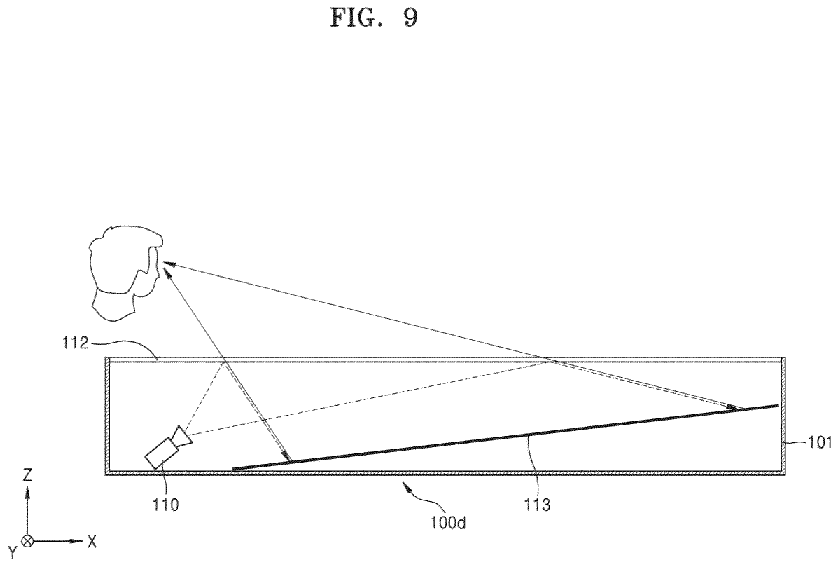

FIG. 9 schematically illustrates a configuration of a three-dimensional display device according to one or more embodiments of the disclosure. It has been described that the mirror 111 is provided in the optical path between the image projector 110 and the beam splitter 112. The mirror 111 is provided to bend the optical path to secure an optical path of a sufficient length from the image projector 110 to the beam splitter 112. However, when a sufficiently long optical path may be secured between the image projector 110 and the beam splitter 112 without the mirror 111, or when the divergence angle α of the image projector 110 is sufficiently large, the mirror 111 may be omitted. Referring to FIG. 9, a three-dimensional display device 100d does not include the mirror 111, and the image projector 110 may be tilted toward the beam splitter 112. In this case, light emitted from the image projector 110 may travel obliquely in the positive (+) first axis direction (i.e., +X-axis direction) and the positive (+) third axis direction (i.e., +Z-axis direction) toward the beam splitter 112.

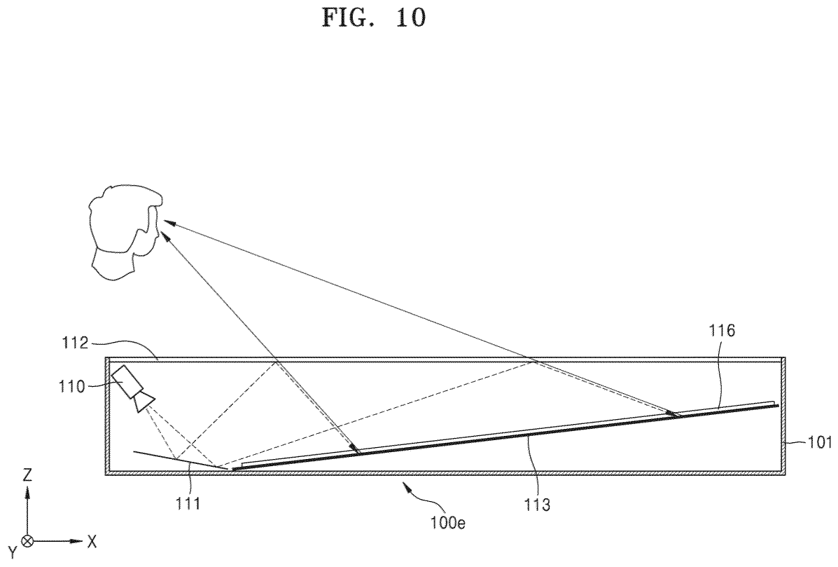

FIG. 10 schematically illustrates a configuration of a three-dimensional display device according to one or more embodiments of the disclosure. Referring to FIG. 10, a three-dimensional display device 100e may further include a diffuser sheet 116 provided on an optical path between the beam splitter 112 and the retroreflector 113. For example, the diffuser sheet 116 may be provided on the reflective surface of the retroreflector 113. The diffuser sheet 116 may be arranged in direct contact with the reflective surface of the retroreflector 113, or may be arranged at a distance from the reflective surface of the retroreflector 113. The diffuser sheet 116 may be configured to expand the viewing area horizontally or vertically. To this end, the diffuser sheet 116 may diffuse light reflected from the retroreflector 113 in the second axis direction (i.e., Y-axis direction) or the third axis direction (i.e., Z-axis direction). The diffuser sheet 116 may be, for example, a lenticular sheet including a plurality of lenticular lenses, or may be an anisotropic diffuser such as a holographic diffuser.

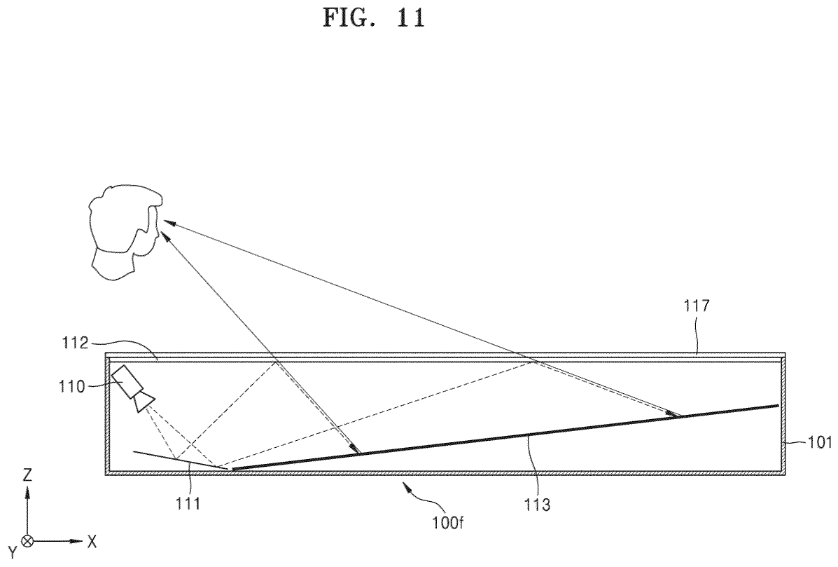

FIG. 11 schematically illustrates a configuration of a three-dimensional display device according to one or more embodiments of the disclosure. Referring to FIG. 11, a three-dimensional display device 100f may further include an anti-reflection layer 117 to reduce image noise. The anti-reflection layer 117 may be provided on the outer surface of the beam splitter 112. For example, when the beam splitter 112 has a first surface on the outside of the three-dimensional display device 100f and a second surface opposite the first surface, the anti-reflection layer 117 may be provided on the first surface of the beam splitter 112, and the image projector 110, the mirror 111, and the retroreflector 113 may be provided to face the second surface of the beam splitter 112. The anti-reflection layer 117 may improve the sharpness of an image by preventing or reducing reflection of light incident on the first surface of the beam splitter 112 from the outside, to the viewing area.

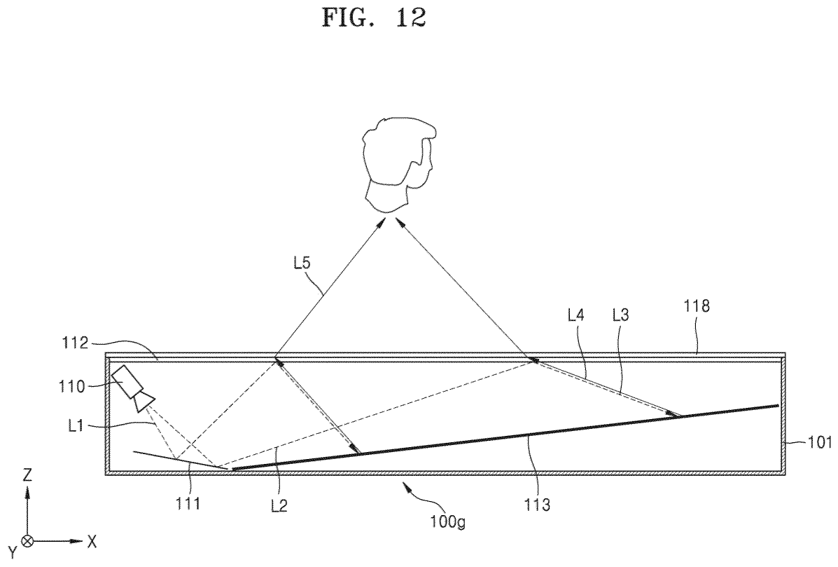

FIG. 12 schematically illustrates a configuration of a three-dimensional display device according to one or more embodiments of the disclosure. Referring to FIG. 12, a three-dimensional display device 100g may further include an optical path changing sheet 118 that shifts the position of the viewing area toward the front of the three-dimensional display device 100g. The above-described three-dimensional display device may be difficult to apply to monitors or televisions (TVs), etc., because it forms a viewing area near an edge of the three-dimensional display device or near an edge of the beam splitter 112. Because a viewing area may be formed in front of the three-dimensional display device 100g or in front of the beam splitter 112 by using the optical path changing sheet 118, the three-dimensional display device 100g may be applied to, for example, monitors or TVs.

The optical path changing sheet 118 may be provided on the outer surface of the beam splitter 112. For example, when the beam splitter 112 has a first surface on the outside of the three-dimensional display device 100g and a second surface opposite the first surface, the optical path changing sheet 118 may be provided on the first surface of the beam splitter 112. The optical path changing sheet 118 may be, for example, a prism sheet including a plurality of microprisms. The optical path changing sheet 118 may be configured to change the direction of travel of light that travels obliquely toward an edge of the beam splitter 112 in the first axis direction (i.e., X-axis direction) after transmitting through the beam splitter 112 from the retroreflector 113, to the direction toward the front of the three-dimensional display device 100g or the direction toward the front of the beam splitter 112.

In the three-dimensional display device 100g further including the optical path changing sheet 118, light may travel from the image projector 110 to the viewing area along five different paths. For example, the optical path from the image projector 110 to the viewing area may include a first optical path L1 from the image projector 110 to the mirror 111, a second optical path L2 from the mirror 111 to the beam splitter 112, a third optical path L3 from the beam splitter 112 to the retroreflector 113, a fourth optical path L4 from the retroreflector 113 to the optical path changing sheet 118, and a fifth optical path L5 from the optical path changing sheet 118 to the viewing area. The light reflected from the retroreflector 113 and then transmitted through the beam splitter 112 may converge on the viewing area while traveling in the third axis direction (i.e., Z-axis direction), that is, in a direction almost perpendicular to the first surface of the beam splitter 112, in the fifth optical path L5.

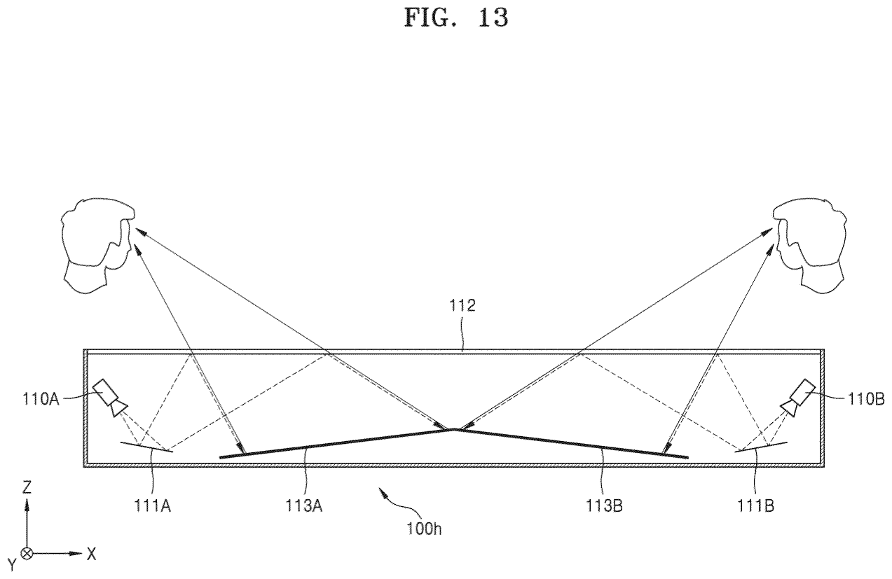

FIG. 13 schematically illustrates a configuration of a three-dimensional display device according to one or more embodiments of the disclosure. Although the above-described display devices have been described as providing only one viewing area, it is also possible to provide two or more viewing areas. Referring to FIG. 13, a three-dimensional display device 100h may include the beam splitter 112, a first image projector 110A, a second image projector 110B, a first mirror 111A, a second mirror 111B, a first retroreflector 113A, and a second retroreflector 113B. The first image projector 110A and the second image projector 110B may be provided near both edges of the beam splitter 112 in the first axis direction (i.e., X-axis direction). The first image projector 110A and the second image projector 110B may be arranged symmetrically with respect to each other, but are not limited thereto. The first image projector 110A may emit a first light containing a first image, and the second image projector 110B may emit a second light containing a second image. The first image and the second image may be identical to or different from each other.

The first mirror 111A may be provided to reflect, toward the beam splitter 112, the first light emitted from the first image projector 110A, and the second mirror 111B may be provided to reflect, toward the beam splitter 112, the second light emitted from the second image projector 110B. The first light reflected from the first mirror 111A may travel obliquely in the positive (+) first axis direction (i.e., +X-axis direction) and the positive (+) third axis direction (i.e., +Z-axis direction) toward the beam splitter 112, and the second light reflected from the second mirror 111B may travel obliquely in the negative (−) first axis direction (i.e., −X-axis direction) and the positive (+) third axis direction (i.e., +Z-axis direction) toward the beam splitter 112. In an example, the first mirror 111A and the second mirror 111B may be arranged symmetrically with respect to each other, but are not limited thereto.

The first retroreflector 113A may be provided to reflect the first light reflected from the beam splitter 112 in the negative (−) first axis direction (i.e., −X-axis direction), and the second retroreflector 113B may be provided to reflect the second light reflected from the beam splitter 112 in the positive (+) first axis direction (i.e., +X-axis direction). The first retroreflector 113A and the second retroreflector 113B may be tilted in opposite directions such that the reflective surface of the first retroreflector 113A and the reflective surface of the second retroreflector 113B do not face each other. The first light reflected from the first retroreflector 113A may pass through the beam splitter 112 in the negative (−) first axis direction (i.e., −X-axis direction) and the positive (+) third axis direction (i.e., +Z-axis direction) and then travel obliquely toward a first viewing area, and the second light reflected from the second retroreflector 113B may pass through the beam splitter 112 in the positive (+) first axis direction (i.e., +X-axis direction) and the positive (+) third axis direction (i.e., +Z-axis direction) and then travel obliquely toward a second viewing area. The first retroreflector 113A and the second retroreflector 113B may be arranged symmetrically with respect to each other, but are not limited thereto.

According to one or more embodiments of the disclosure, two viewing areas may be formed near both edges of the three-dimensional display device 100h. For example, the first viewing area may be formed near an edge of the three-dimensional display device 100h in the negative (−) first axis direction (i.e., −X-axis direction), and the second viewing area may be formed near an edge of the three-dimensional display device 100h in the positive (+) first axis direction (i.e., +X-axis direction). Accordingly, users may view three-dimensional images at both edges of the three-dimensional display device 100h. When the first image projector 110A and the second image projector 110B are arranged symmetrically with respect to each other, the first mirror 111A and the second mirror 111B are arranged symmetrically with respect to each other, and the first retroreflector 113A and the second retroreflector 113B are arranged symmetrically with respect to each other, the positions of the first viewing area and the second viewing area may be symmetrical with each other, but the disclosure is not limited thereto.

FIG. 13 illustrates a case in which two viewing areas are formed on both sides in the first axis direction (i.e., X-axis direction), but the disclosure is not limited thereto. For example, two image forming devices, two mirrors, and two retroreflectors may be further provided on both sides in the second axis direction (i.e., Y-axis direction). Accordingly, two more viewing areas may be further formed on both sides in the second axis direction (i.e., Y-axis direction).

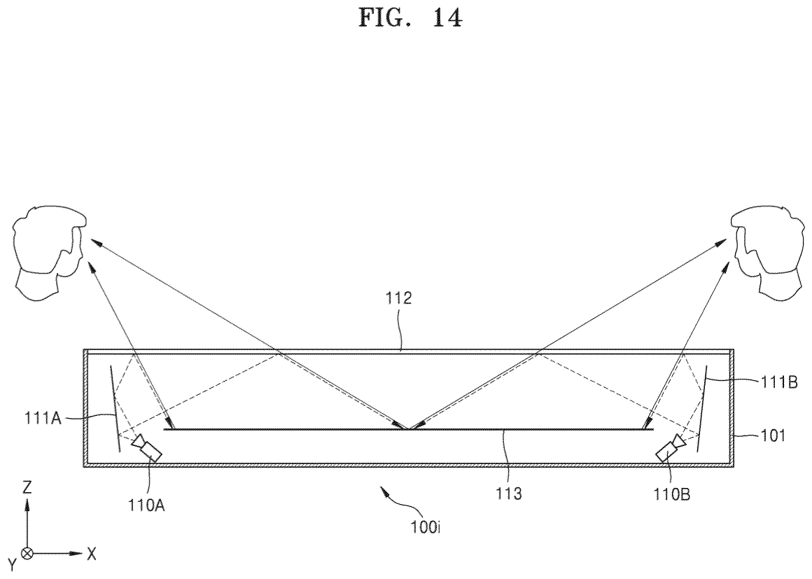

FIG. 14 schematically illustrates a configuration of a three-dimensional display device according to one or more embodiments of the disclosure. The three-dimensional display device 100h illustrated in FIG. 13 includes two retroreflectors, i.e., the first retroreflector 113A and the second retroreflector 113B, but it is also possible to use only one retroreflector when the retroreflector is arranged parallel to the beam splitter 112. Referring to FIG. 14, a three-dimensional display device 100i may include the beam splitter 112, the first image projector 110A, the second image projector 110B, the first mirror 111A, the second mirror 111B, and the retroreflector 113.

The beam splitter 112 and the retroreflector 113 may be provided parallel to each other. For example, the beam splitter 112 and the retroreflector 113 may be arranged to be parallel to a horizontal plane formed by the first axis direction (i.e., X-axis direction) and the second axis direction (i.e., Y-axis direction) and to face each other in the third axis direction (i.e., Z-axis direction) with a gap therebetween. The first image projector 110A and the second image projector 110B may be provided on both sides of the beam splitter 112 and the retroreflector 113 in the first axis direction (i.e., X-axis direction), respectively. In addition, the first mirror 111A and the second mirror 111B may also be provided on both sides of the beam splitter 112 and the retroreflector 113 in the first axis direction (i.e., X-axis direction), respectively. In other words, the retroreflector 113 may be provided between the first image projector 110A and the second image projector 110B or between the first mirror 111A and the second mirror 111B in the first axis direction (i.e., X-axis direction).

Although the three-dimensional display device including the retroreflector is described above with reference to embodiments illustrated in the drawings, the embodiments are merely examples, and it will be understood by one of skill in the art that various modifications and equivalent embodiments may be made therefrom. Therefore, the disclosed embodiments are to be considered in a descriptive sense only, and not for purposes of limitation. The scope of the disclosure is in the claims rather than the above descriptions, and all differences within the equivalent scope should be construed as being included in the disclosure.

What is claimed is:

1. A display device comprising:
a beam splitter comprising a first surface and a second surface opposite to the first surface, the beam splitter being configured to reflect a first part of incident light and transmit a second part of the incident light;
a retroreflector facing the second surface of the beam splitter, the retroreflector being configured to reflect the incident light back in a direction opposite to a direction in which the incident light is incident upon the retroreflector; and
an image projector on a side of the second surface of the beam splitter, the image projector being configured to emit a light providing an image,
wherein the image projector, the beam splitter, and the retroreflector are arranged such that the light emitted from the image projector is incident on the second surface of the beam splitter while diverging obliquely, the incident light reflected from the beam splitter is incident on the retroreflector while diverging obliquely, and the incident light reflected by the retroreflector is incident on the second surface of the beam splitter while converging obliquely.

2. The display device of claim 1, wherein the image projector comprises at least two image providing elements configured to respectively provide images with different viewpoints.

3. The display device of claim 2, wherein the beam splitter is parallel to a plane defined by a first axis direction and a second axis direction perpendicular to the first axis direction,
wherein the light emitted from the image projector travels in the first axis direction, and
wherein the at least two image providing elements are arranged in the second axis direction.

4. The display device of claim 1, wherein the retroreflector is parallel to the beam splitter or is tilted at less than 45 degrees with respect to the beam splitter.

5. The display device of claim 1, further comprising a mirror that faces the second surface of the beam splitter,
wherein the mirror is configured to reflect, toward the beam splitter, the light emitted from the image projector,
wherein the beam splitter is parallel to a plane defined by a first axis direction and a second axis direction perpendicular to the first axis direction, and
wherein the mirror and the retroreflector are adjacent to each other in the first axis direction.

6. The display device of claim 5, wherein the mirror and the retroreflector are tilted in opposite directions such that a reflective surface of the mirror and a reflective surface of the retroreflector face each other.

7. The display device of claim 5, wherein the mirror is tilted at a first angle with respect to the first axis direction,
wherein the retroreflector is tilted at a second angle with respect to the first axis direction, and
wherein the first angle and the second angle are greater than or equal to 0 degrees and less than 45 degrees.

8. The display device of claim 5, wherein a reflective surface of the mirror and a reflective surface of the retroreflector are parallel to and face the beam splitter.

9. The display device of claim 5, wherein the image projector is arranged between the mirror and the beam splitter in a third axis direction that is perpendicular to the first axis direction and the second axis direction.

10. The display device of claim 5, wherein the image projector is between the mirror and the retroreflector in the first axis direction, and
wherein the mirror is tilted at an angle of less than 45 degrees with respect to a third axis direction, the third axis direction being perpendicular to the first axis direction and the second axis direction.

11. The display device of claim 10, wherein the retroreflector is between the beam splitter and the image projector in the third axis direction.

12. The display device of claim 10, wherein a reflective surface of the mirror and a reflective surface of the retroreflector are perpendicular to each other.

13. The display device of claim 5, wherein the incident light reflected by the retroreflector and transmitted through the beam splitter converges into a viewing area adjacent to an edge of the beam splitter in the first axis direction.

14. The display device of claim 1, further comprising a mirror that faces the second surface of the beam splitter,
wherein the mirror is configured to reflect, toward the beam splitter, the light emitted from the image projector, and
wherein the mirror comprises a convex reflective surface.

15. The display device of claim 1, further comprising a diffuser sheet on an optical path between the beam splitter and the retroreflector, the diffuser sheet being configured to expand a viewing area by diffusing the light reflected from the retroreflector.

16. The display device of claim 1, further comprising an anti-reflection layer on the first surface of the beam splitter, the anti-reflection layer being configured to reduce reflection of light incident on the first surface of the beam splitter.

17. The display device of claim 1, further comprising an optical path changing sheet on the first surface of the beam splitter, the optical path changing sheet being configured to change a direction of travel of the incident light transmitted through the beam splitter from the retroreflector, toward a front of the beam splitter.

18. The display device of claim 1, wherein the image projector comprises a first image projector configured to emit a first light providing a first image, and a second image projector configured to emit a second light providing a second image,
wherein the retroreflector comprises a first retroreflector configured to reflect the first light reflected from the beam splitter, and a second retroreflector configured to reflect the second light reflected from the beam splitter,
wherein the first image projector and the second image projector are respectively adjacent to each edge of the beam splitter, and
wherein the first retroreflector and the second retroreflector are tilted in opposite directions such that a reflective surface of the first retroreflector and a reflective surface of the second retroreflector do not face each other.

19. The display device of claim 1, wherein the image projector comprises a first image projector configured to emit a first light providing a first image, and a second image projector configured to emit a second light providing a second image,
wherein the beam splitter and the retroreflector are parallel to each other, and
wherein the retroreflector is between the first image projector and the second image projector.

20. A display device comprising:
a beam splitter configured to reflect a first part of light incident on the beam splitter and to transmit a second part of light incident on the beam splitter;
a retroreflector facing a surface of the beam splitter, the retroreflector being configured to reflect light reflected from the beam splitter in a direction opposite to a direction in which the light reflected from the beam splitter is incident upon the retroreflector; and
an image projector configured to emit light providing an image,
wherein the image projector is configured to emit the light providing the image toward the surface of the beam splitter while diverging obliquely,
wherein the beam splitter is configured to reflect at least a portion of the light comprising the image toward the retroreflector while diverging obliquely, and
wherein the retroreflector is configured to reflect the at least the portion of the light comprising the image toward the surface of the beam splitter while converging obliquely.
